(19) United States
(12) Patent Application Publication
(10) Pub. No.: US 2006/0246810 A1
(43) Pub. Date: Nov. 2, 2006

(54) Method of manufacturing field emission device (FED) having carbon nanotube (CNT) emitter

(76) Inventors: Hang-Woo Lee, Suwon-si (KR); Shang-Hyeun Park, Boryeong-si (KR)

Correspondence Address: Robert E. Bushnell, Suite 300, 1522 K Street, N.W., Washington, DC, 20005-1202, US

(21) Appl. No.: 11/316,980

(22) Filed: Dec. 27, 2005

(30) Foreign Application Priority Data
Feb. 1, 2005 (KR) 10-2005-0009108

(51) Int. Cl. H01J 9/24

(52) U.S. Cl. 445/24; 977/844

(57) ABSTRACT

A method of manufacturing a Field Emission Device (FED) having a Carbon NanoTube (CNT) emitter includes: forming an emitter hole to expose a cathode electrode in an insulating layer after sequentially forming the cathode electrode, the insulating layer, and a gate electrode; forming a sacrificial layer by patterning a photoresist until the cathode electrode in a lower part of the emitter hole is exposed after coating the photoresist to cover the gate electrode and the exposed portion of the cathode electrode; coating a CNT paste on the sacrificial layer to fill the emitter hole, and removing the sacrificial layer while simultaneously forming the CNT emitter in the emitter hole by firing the CNT paste.

### CLAIM OF PRIORITY

This application makes reference to, incorporates the same herein, and claims all benefits accruing under 35 U.S.C.§119 from an application earlier filed in the Korean Intellectual Property Office on 1 Feb. 2005 and there duly assigned Serial No. 10-2005-0009108.

### BACKGROUND OF THE INVENTION

1. Field of the Invention

The present invention relates to a method of manufacturing a Field Emission Device (FED), and more particularly, to a method of manufacturing a FED having a Carbon NanoTube (CNT) emitter.

2. Description of the Related Art

A Field Emission Device (FED) applies a strong electric field between an emitter disposed on a cathode electrode and a gate electrode, thereby emitting electrons from the emitter, colliding the electrons with a fluorescent material on an anode electrode, and emitting light. Conventionally, a micro tip composed a metal such as Mo was used as an emitter of an FED, but recently, Carbon NanoTubes (CNTs) have been used as the emitter of an FED, due to their superior field emission characteristics.

A FED that uses a CNT emitter can be applied to various electronic devices, such as a car navigator or a viewfinder of electronic image devices, due to its wide viewing angle, high resolution, and low power consumption. Especially, the FED can be used as a display device in personal computers, terminals of Personal Data Assistants (PDAs), medical equipment, and High Definition TeleVisions (HDTVs), and can also be used as a backlight of liquid crystal devices.

A method of manufacturing a FED having a CNT emitter includes, after sequentially stacking a cathode electrode, an insulating layer, and a gate electrode on a substrate, an emitter hole that exposes a portion of the cathode electrode is formed in the insulating layer. Next, after coating a photoresist on the surfaces of the gate electrode and the exposed cathode electrode, a sacrificial layer that exposes the cathode electrode in the emitter hole is formed by patterning the photoresist. A CNT paste is coated on the entire surface of the resultant product. Afterward, the CNT paste 6 is selectively exposed by irradiating ultraviolet rays from the back side of the substrate using a back-side exposure method. At this time, the exposed portion of the CNT paste is cured. When the unexposed CNT paste and the sacrificial layer are removed by developing using a developing agent, such as acetone, only the exposed portion of the CNT paste remains in the emitter hole. When the CNT paste is fired, a CNT emitter is formed in the emitter hole. When the surface of the CNT emitter is treated, pure CNTs are aligned on the surface of the CNT emitter.

However, the method of manufacturing a FED described above has a problem in that the adhesion force of the CNT emitter to the cathode electrode is reduced due to the developing process. Also, there is a problem in that there is a remaining residue at an interface between the CNT paste and the sacrificial layer. This residue can form undesired images, thereby degrading the image quality.

### SUMMARY OF THE INVENTION

The present invention provides a method of manufacturing a Field Emission Device (FED), which can improve the efficiency of a process by firing the CNT paste and removing the sacrificial layer at the same time.

The present invention also provides a method of manufacturing a FED comprising: forming sequentially a cathode electrode, an insulating layer, and a gate electrode on a substrate, and forming an emitter hole that exposes the cathode electrode in the insulating layer; coating a photoresist to cover the gate electrode and the exposed portion of the cathode electrode, and forming a sacrificial layer by patterning the photoresist until the cathode electrode in the part of the emitter hole is exposed; coating a Carbon NanoTube (CNT) paste on the sacrificial layer to fill the emitter hole; and removing the sacrificial layer while simultaneously forming the CNT emitter in the emitter hole by firing the CNT paste.

The photoresist may include acrylic polymer.

The method can further comprise aligning pure CNTs on the upper surface of the CNT emitter by treating the surface of the CNT emitter formed in the emitter hole, and also removing the upper surface of the CNT paste coated on the sacrificial layer until the sacrificial layer is exposed.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIGS. 1A through 1E are cross-sectional views of a method of manufacturing a Field Emission Device (FED);

FIG. 2 is a photograph of residue generated at an interface between a Carbon NanoTube (CNT) paste and a sacrificial layer in a FED manufactured by the method of FIGS. 1A through 1E;

FIGS. 3A through 3E are cross-sectional views of a method of manufacturing a FED according to an embodiment of the present invention; and

FIGS. 4A and 4B are respectively photographs of before and after firing of a photoresist that includes an acrylic polymer.

### DETAILED DESCRIPTION OF THE INVENTION

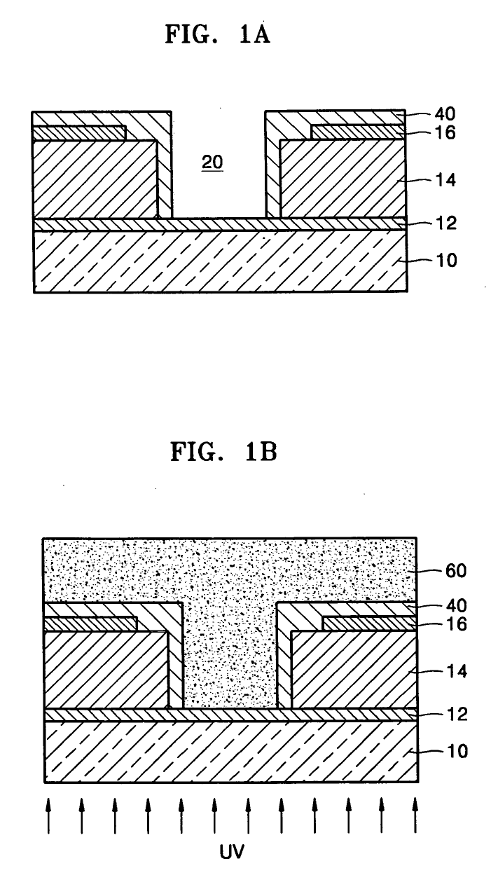

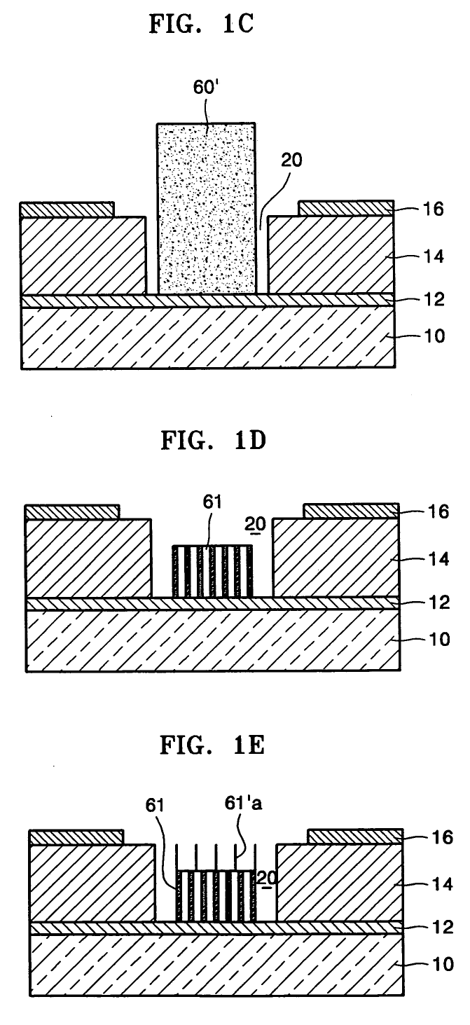

FIGS. 1 through 1E are cross-sectional views of a method of manufacturing a Field Emission Device (FED) having a Carbon NanoTube (CNT) emitter.

Referring to FIG. 1A, after sequentially stacking a cathode electrode 12, an insulating layer 14, and a gate electrode 16 on a substrate 10, an emitter hole 20 that exposes a portion of the cathode electrode 16 is formed in the insulating layer 14. Next, after coating a photoresist on the surfaces of the gate electrode 16 and the exposed cathode electrode 12, a sacrificial layer 40 that exposes the cathode electrode 12 in the emitter hole 20 is formed by patterning the photoresist. Referring to FIG. 1B, a CNT paste 60 is coated on the entire surface of the resultant product of FIG. 1A. Afterward, the CNT paste 60 is selectively exposed by irradiating ultraviolet rays from the back side of the substrate 10 using a back-side exposure method. At this time, the exposed portion of the CNT paste 60 is cured. Referring to FIG. 1C, when the unexposed CNT paste 60 and the sacrificial layer 40 are removed by developing using a developing agent, such as acetone, only the exposed portion of the CNT paste 60′ remains in the emitter hole 20. Referring to FIG. 1D, when the CNT paste 60′ is fired, a CNT emitter 61 is formed in the emitter hole 20. Referring to FIG. 1E, when the surface of the CNT emitter 61 is treated, pure carbon nanotubes are aligned on the surface of the CNT emitter 61.

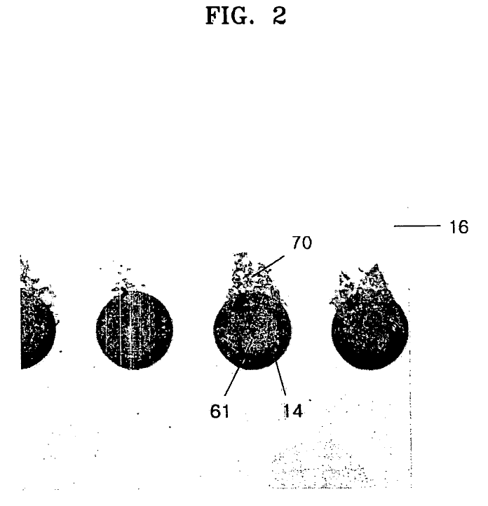

However, the method of manufacturing a FED described above has a problem in that the adhesion force of the CNT emitter 61 to the cathode electrode 12 is reduced due to the developing process. Also, as depicted in FIG. 2, there is a problem in that there is a remaining residue 70 at an interface between the CNT paste and the sacrificial layer. This residue 70 can form undesired images, thereby degrading the image quality.

The present invention will now be described more fully with reference to the accompanying drawings in which embodiments of the present invention are shown. Like reference numerals refer to like elements throughout the drawings.

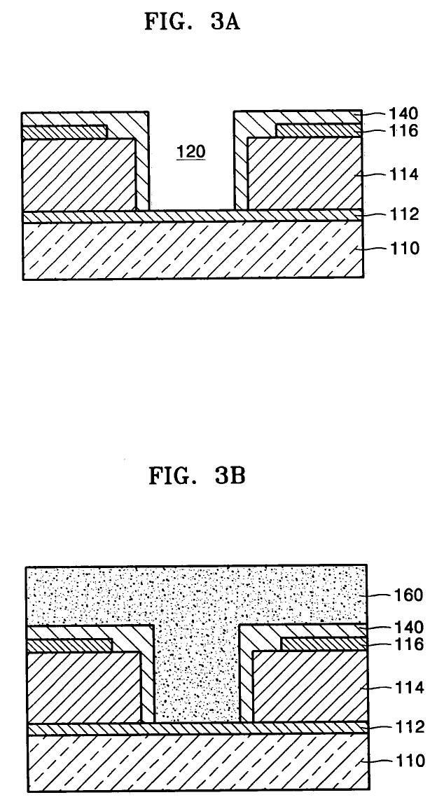

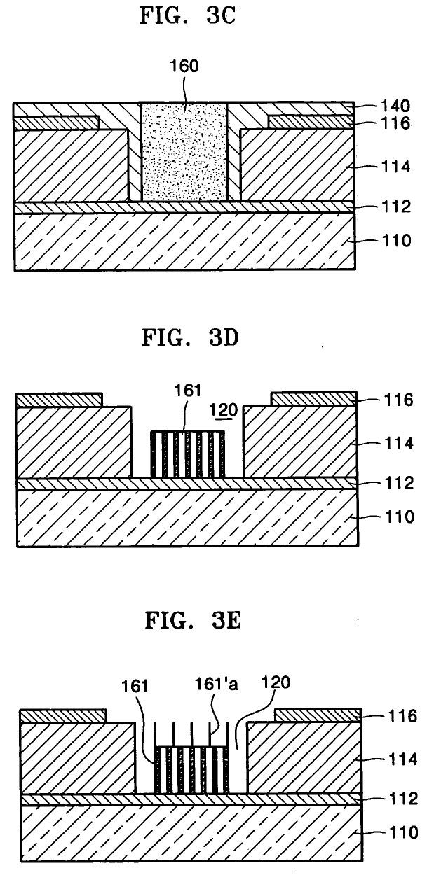

FIGS. 3A through 3E are cross-sectional views of a method of manufacturing a FED according to an embodiment of the present invention.

Referring to FIG. 3A, after sequentially stacking a cathode electrode 112, an insulating layer 114, and a gate electrode 116 on a substrate 110, an emitter hole 120 that exposes a portion of the cathode electrode 116 is formed in the insulating layer 114. The substrate 110 can be formed of glass. The cathode electrode 112 can be formed of a transparent conductive material, such as Indium Tin Oxide (ITO), and the gate electrode 116 can be formed of a conductive metal, such as Cr.

More specifically, after depositing a transparent conductive material, such as ITO, on the substrate 110, a cathode electrode 112 is formed by patterning the transparent conductive material into a shape, such as a strip shape. Next, an insulating layer 114 is formed on the substrate 110 to cover the cathode electrode 112. Afterward, a conductive metal, such as Cr, is deposited on the insulating layer 114 using sputtering. A gate electrode 116 is formed by patterning the conductive metal. An emitter hole 120 is formed by etching the insulating layer 114 exposed though the gate electrode 116 until the cathode electrode 112 is exposed.

Next, after coating a photoresist to cover the gate electrode 116 and the exposed cathode electrode 112, a sacrificial layer 140 that exposes the cathode electrode 112 in a lower part of the emitter hole 120 is formed by patterning the photoresist. The photoresist that forms the sacrificial layer 140 can include an acrylic polymer, so that it can be removed by a firing process of a CNT paste 160 which will be described later.

Referring to FIG. 3B, a CNT paste 160 is coated on the sacrificial layer 140 to completely fill the emitter hole 120. The CNT paste 160 can be coated by a printing method. Referring to FIG. 3C, the upper part of the CNT paste 160 coated on the sacrificial layer 140 is removed until the sacrificial layer 140 is exposed.

Next, when the CNT paste 160 is fired, as depicted in FIG. 3D, a CNT emitter 161 is formed in the emitter hole 120, and the sacrificial layer 140 formed of a photoresist is removed. The sacrificial layer 140 is removed in the firing process because, as described above, the photoresist that constitutes the sacrificial layer 140 includes an acrylic polymer, for example, which is burned away during the firing process.

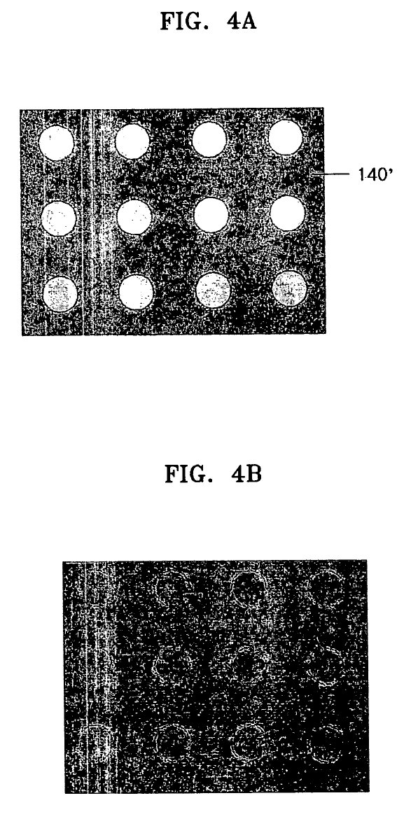

FIGS. 4A and 4B are respectively photographs of before and after firing a photoresist 140′ that includes an acrylic polymer. The photoresist 140′ is heated to a temperature of approximately 460 degrees C. under an N2 atmosphere. Referring to FIGS. 4A and 4B, most of the photoresist 140′ is removed by the firing process.

Finally, when the surface of the CNT emitter 161 formed in the emitter hole 120 is treated using an adhesive tape, pure CNTs 161a are vertically aligned on the upper surface of the CNT emitter 161.

As described above, the method of manufacturing a FED according to the present invention has the following advantages.

First, the process efficiency can be improved by removing the sacrificial layer while simultaneously firing the CNT paste.

Second, residue is prevented at an interface between the sacrificial layer and the CNT paste, by removing an exposure process.

Third, the adhesion force of the CNT emitter with respect to the cathode electrode can be improved by removing a developing process.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. A method of manufacturing a Field Emission Device (FED), the method comprising:
sequentially forming a cathode electrode, an insulating layer, and a gate electrode on a substrate, and forming an emitter hole to expose the cathode electrode in the insulating layer;
coating a photoresist to cover the gate electrode and the exposed portion of the cathode electrode, and forming a sacrificial layer by patterning the photoresist until the cathode electrode in the part of the emitter hole is exposed;
coating a Carbon NanoTube (CNT) paste on the sacrificial layer to fill the emitter hole; and
removing the sacrificial layer while simultaneously forming the CNT emitter in the emitter hole, by firing the CNT paste.

2. The method of claim 1, wherein the photoresist includes an acrylic polymer.

3. The method of claim 1, further comprising aligning pure CNTs on an upper surface of the CNT emitter by treating the surface of the CNT emitter formed in the emitter hole.

4. The method of claim 3, wherein the surface of the CNT emitter is treated with an adhesive tape.

5. The method of claim 1, further comprising removing an upper surface of the CNT paste coated on the sacrificial layer until the sacrificial layer is exposed.

6. The method of claim 1, wherein the CNT paste is coated on the sacrificial layer with a printing method.

7. The method of claim 1, wherein the substrate is a glass substrate.

8. The method of claim 1, wherein the cathode electrode is formed of Indium Tin Oxide (ITO).

9. The method of claim 1, wherein the gate electrode is formed of Cr.
